(19) United States
(12) Patent Application Publication
(10) Pub. No.: US 2004/0006696 A1
(43) Pub. Date: Jan. 8, 2004

(54) Watermark embedding and extracting method for protecting digital audio contents copyright and preventing duplication and apparatus using thereof

(76) Inventors: Seung-Won Shin, Seoul (KR); Jong-Weon Kim, Seoul (KR); Han-Ho Lee, Seoul (KR); Chang-Mok Park, Seoul (KR)

Correspondence Address: Stephen M De Klerk, Blakely Sokoloff Taylor & Zafman, Seventh Floor, 12400 Wilshire Boulevard, Los Angeles, CA, 90025-1026, US

(21) Appl. No.: 10/297,818

(22) PCT Filed: Jun. 8, 2001
(86) PCT No.: PCT/KR01/00975

(30) Foreign Application Priority Data
Jun. 8, 2000 (KR) 2000/31255
Jun. 10, 2000 (KR) 2000/31931

(51) Int. Cl. H04L 9/00

(52) U.S. Cl. 713/176

(57) ABSTRACT

In embedding a watermark in a digital audio contents, a model using a minimum audible limit of the digital audio contents is generated and a series of pseudo random number is masked to generate the watermark to be inserted in the digital audio contents In order to extract the watermark embedded in the digital audio contents, an auditory psychological model having a minimum audible limit, which depends on the characteristic of frequency generated from the digital audio contents, is formed to generate the watermark from a series of pseudo random number. After generating the watermark, the length of the watermark is adjusted according to the relationship of a signal processing between the adjacent digital audio contents. By measuring the correlation between the watermark and digital audio contents, it is possible to detect whether the watermark is inserted or not.

### BACKGROUND OF THE INVENTION

1. Field of the Invention

The present invention relates to watermark embedding and extracting method in/from digital contents and, in particular, a method and device for embedding watermark in digital audio contents in which watermark is able to be embedded even in a case the digital audio contents have its periodic characteristics and are susceptible only to a minor change in quality, and a method and device for extracting watermark from the watermark-embedded digital audio contents even in case the original contents are in the state of distortion from the attacks of the watermark-embedded digital audio contents by signal processing.

2. Description of the Related Art

Embedding/extracting watermark in/from the digital audio contents is suggested in “Digital Watermarks for Audio Signals” (Laurence Boney, A. H. Tewfik, and K. N. Hamdy, in Proc, 1996 IEEE Int. Conf. Multimedia Computing and Systems, and Hiroshima, Japan, Jun. 17-23, 1996, pp. 473-480). Embedding watermark using psycho-acoustic model is suggested by Swanson et al. in “Robust Data Hiding for Images” (M. D. Swanson, B. Zu, and A. H. Tewfik, in Information Hiding: Second Int. Workshop (Lecture Notes in Computer Science), vol. 1525, D. Aucsmith, Ed. Berlin, Germany: Springer-Verlag, 1998, pp. 169-190).

The methods for embedding watermark disclosed in Laurence et al. and Swanson et al. are generally known technology. The technology disclosed in Laurence et al. should analyze audio contents per frame and thus a large amount of computation and memory are necessary. Thereby, it is difficult to be practically commercialized.

Further, a method for detecting watermark using correlation widely used in a research relating to the watermarking is the same as a method used in a research of “A Secure Robust Watermark for Multimedia,” (I. J. Cox, J. Kilian, T. Leighton, and T. Shamoon in R. J. Anderson, Ed., “Information hiding: First International Workshop,” in Lecture Notes in Computer Science, vol. 1174, Berlin, Germany: Springer-Verlag, 1996, pp. 183-206) of Cox et al. and “Secure Spread Spectrum Watermarking for Images, Audio, and Video” (I. J. Cox, J. Kilian, T. Leighton, and T. Shammon in Proc. IEEE Int, Conf, Image Processing (ICIP'96), Lausanne, Switzerlandm Sept. 16-19, 1996, pp. 243-246). However, such a method will cause a problem in which the ratio of detecting watermark just with a simple correlation after the contents are attacked is significantly lowered due to a periodic characteristic of the audio contents.

Further, the digital audio contents have a very close relation with a magnitude of the surrounding signal in respect of its characteristics. Hence, the form of wave of an audio signal itself is comprised of the sum of sine waves (sine curve and cosine curve) having different frequencies to each other. That is, since the sine waves are periodic functions and have periodic characteristics so that a watermark is embedded with such a strength as not to damage quality of the digital audio signals, a frequent concealment of the correlation information occurs under the periodic characteristics of the audio and thus is not perceived.

As an alternative of resolving the above-mentioned problem, International Patent Laid-Open No. WO9803014 suggests an improvement to strengthen the information of watermark by filtering the watermark-embedded digital contents and watermark signal with a predicting filter before finding the correlation function between the digital contents signal and watermark. The above-mentioned International Patent Laid-Open discloses a method for detecting the watermark which includes a step of evaluating the correlation produced by correlating the digital contents and watermark embedded in the information signal. In this case, the watermark-embedded digital contents and watermark are filtered with the predicting filter according to the characteristics of the digital contents, and the resultant correlation is applied to the filtered signal and filtered watermark.

However, the above International Patent Laid-Open explains an embodiment for the object of an image, which is less periodical compared to that of a filtering which requires a considerable time for computation in filtering the watermark-embedded digital contents by a predicting filter, and thus it is impossible to apply to a system requiring a real-time application.

### SUMMARY OF THE INVENTION

An object of the present invention in order to resolve problems as mentioned above is to provide a method for real-time embedding and extracting a watermark without affecting the quality of the audio and a device using the same .

Another object of the present invention is to provide a method for embedding/extracting a digital watermark and a device using the same, which is able to make the whole process of real time embedding/extracting watermark and can be applied to a portable device such as a MP3 player.

Another object of the present invention is to provide a method for embedding a digital watermark and a device using the same which designs and embeds a watermark using a domain undistinguishable by human audibility.

The embedding watermark as mentioned above is done in a domain of a time-spatial space, and a masking method using a digital psycho-acoustic model suggested in the present invention, i.e. audio absolute threshold curves of hearing before the step of embedding watermark is provided.

Another object of the present invention is to provide a method that is able to detect an embedded watermark excluding the periodic characteristics essential to the digital audio and a device using the same.

In order to accomplish the above objects, the method for embedding watermark in the digital audio contents including the step of generating the digital watermark by filtering a predetermined length of pseudo random sequence with an audio absolute threshold of hearing in order not to affect the audio characteristics of the digital audio contents; and the step of embedding the digital watermark in the digital audio contents.

The method for extracting watermark from the digital audio contents includes a step of generating watermark from pseudo random number sequence by forming a psycho-acoustic model having an audio absolute threshold of hearing according to the characteristics of the frequency generated from said digital audio contents; a step of adjusting the length of said watermark by detecting whether or not the signal is processed with regard to the corresponding digital audio contents from the digital audio contents which are adjacent to each other after said step of generating watermark; and a step of detecting the embedding of watermark by measuring the correlation between said watermark and said digital audio contents.

The above step of detecting the watermark in the method for detecting a watermark according to the present invention, first, decides on how much a signal processing performed on the digital contents affects the strength and delay of watermark. In particular, it is very critical to make sure that a counter-measure be made when a portion of the watermark disappears, which enables a successful detection of watermark.

Secondly, the signal of watermark embedded in the digital audio data must be strengthened. If watermark affects a tone quality or tone color of the digital contents, it is meaningless even though the watermark can be successfully discriminated. In conclusion, the weak watermark signal must be strengthened, since the watermark signal can not be but be weakly embedded into a signal.

Thirdly, only the identifying signal of watermark must be selectively extracted through the correlation function between watermark-embedded digital signals and watermark. In a process of extracting the watermark signal, the correlation between the signal contents and watermark signal inevitably makes an accurate extraction difficult. Hence, a method of extracting watermark using a signal processing method which removes the periodic characteristics of an audio from the signal generated in the correlation function between the embedded watermark and watermark signal.

The present invention provides a method for extracting watermark embedded in the signal with a strong periodicity such as the digital audio in a high-speed manner and with effectiveness. It is possible to extract the embedded information by this extraction method as long as deterioration in the quality of the audio contents maintains the commercial value of audio even after the attack of an audio signal processing (analog to digital transformation, transformation in a sampling ratio, transformation in a linear speed, lossy compression, echo hiding).

More detailed explanation on watermark embedding and extracting method for protecting digital audio contents copyright and preventing duplication and apparatus using thereof is presented hereinbelow in reference to the attached drawings.

### BREIF DESCRIPTION OF THE DRAWINGS

FIG. 1 is a schematic block diagram showing constitution of a device for embedding the digital watermark according to the present invention.

FIG. 2 is a schematic block diagram showing constitution of the watermark design unit in FIG. 1.

FIG. 3 is a schematic block diagram showing constitution of the watermark embedding unit in FIG. 1.

FIG. 4 is a schematic block diagram showing constitution of a device for extracting the digital watermark according to the present invention

FIG. 5 is a schematic block diagram showing constitution of the watermark design unit in FIG. 4.

FIG. 6 is a detailed block diagram showing the signal variation sensing unit in FIG. 4.

FIG. 7 is a detailed block diagram showing the watermark detecting unit in FIG. 4.

FIG. 8 is a schematic block diagram showing constitution of the watermark information authentication unit which extracts the information and whether or not the watermark is embedded from the watermark detecting unit in FIG. 4.

FIG. 9 is a graph showing audio absolute threshold curves of hearing.

FIG. 10A is a graph showing the result obtained by using the conventional method for calculating the information of correlation, and FIG. 10B is a graph showing the result obtained by using a method for detecting a watermark suggested in the present invention.

FIG. 11 is a graph showing the result of detecting watermark after lossy compression.

FIG. 12 is a graph showing the result of extracting watermark in case of 4-bit information.

### DETAILED DESCRIPTION OF PREFERRED EMBODIMENT

First, a method for embedding the digital watermark and a device using the same relating to the digital audio contents will be explained referring to the drawings from a method for embedding/extracting a watermark and device using the same relating to the digital audio contents according to the present invention.

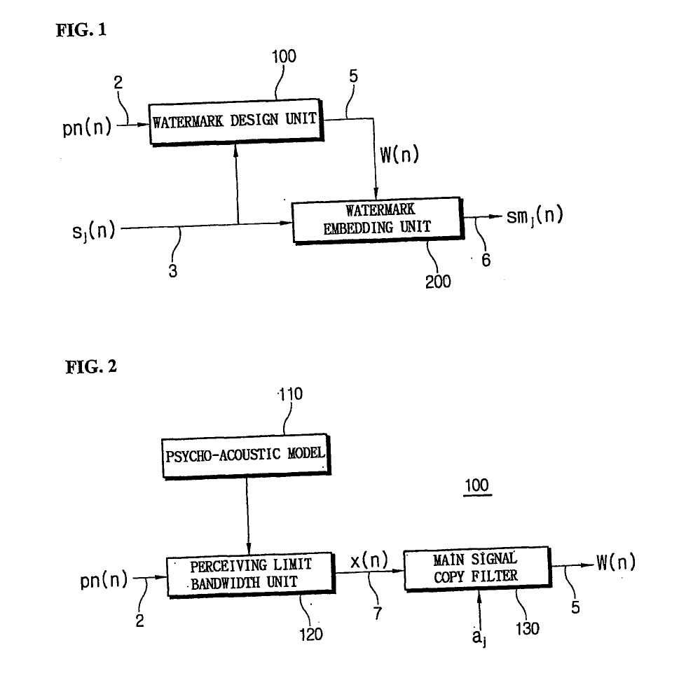

FIG. 1 is a schematic block diagram showing constitution of a device for embedding the digital watermark according to the present invention. In FIG. 1, numeral 100 indicates a watermark design unit for designing a digital watermark in order to minimize influence on a quality of audio considering the characteristics of the digital contents, and numeral 200 indicates a watermark embedding unit for embedding the digital watermark generated from the watermark design unit into the digital contents.

The watermark design unit 200 designs watermark w(n) 5 by using input pseudo-random sequence pn(n) 2, so as not to minimize influence on an audibility of the corresponding digital contents sⱼ(n) 3. The designed watermark is adjusted suitably to the amount of energy of the digital contents sⱼ(n) input by the watermark embedding unit 200 and is added to the digital contents, thereby the watermark-embedded digital contents sⱼ(n) are provided.

FIG. 2 is a schematic block diagram showing constitution of the watermark design unit in FIG. 1 and illustrates the constitution for designing the watermark which can be harmonized with the digital contents sⱼ(n) from the input pseudo-random sequence pn(n) 2. The watermark design unit 100 includes a psycho-acoustic (visual) model 110, a perceiving limit bandwidth filter (audio absolute threshold filter of. hearing) 120, and a main signal copy filter 130 for copying the characteristics of the digital contents as the object of embodiment.

The pseudo-random sequence pn(k) which is put into the watermark design unit 100 is transformed into the filtered signal x(n) by using a model provided by the psycho-acoustic (visual) model 110 through the perceiving limit bandwidth filter 120. A signal wn(n) is provided through a main signal copy filter 130 by using a composed filtering coefficient (a) which represents general characteristics of the digital contents so that the filtered signal x(n) makes a watermark with a property similar to the characteristics of the digital contents. At this time, the perceiving limit bandwidth filter 120 is a filter with audio absolute threshold curve to which human listens the music referring to a curve computed by a statistical analysis in regard to the audio signal.

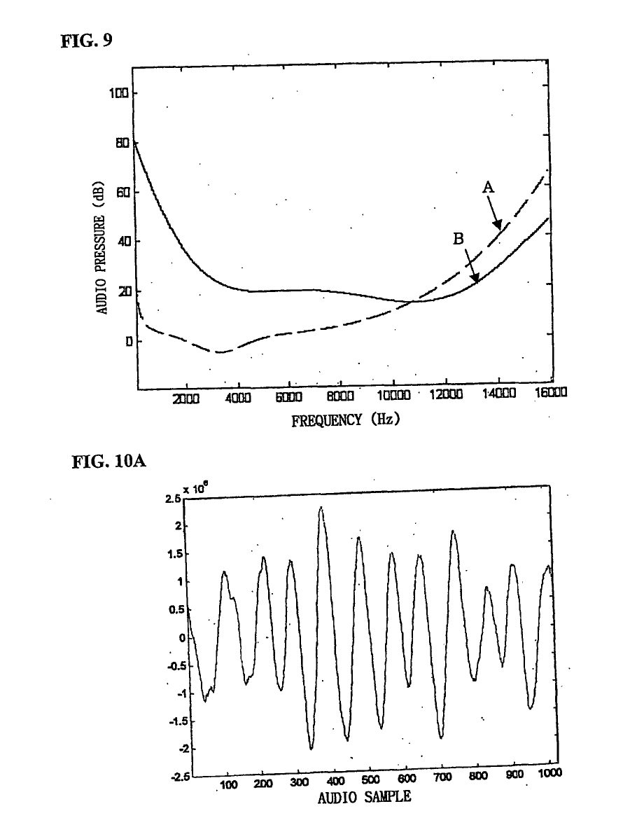

Usually, the audio absolute threshold of hearing is the minimum level of audio perceivable by hearing when it is silent, and means the limit of noise perceivable by hearing when it is silent. Graph A among the graphs shown in FIG. 9 shows the audio absolute threshold of hearing when it is silent, which varies according to the frequency of sound (high and low of sound). That is, even the same volume of audio can be heard or can not according to the frequency.

However, what is intended by the present invention is directed not to the audio absolute threshold of hearing as a general concept described in the above but to the audio absolute threshold of hearing shown usually when the music is played. That is, like graph B of FIG. 9, it means the limit of noise perceivable by hearing at least when the music is played as a result from the analysis of the frequency distribution regarding the different genre of music.

On the supposition of such basic term, the above process presented in an equation is as follows:

$$\begin{matrix}x ( n ) = {\sum }_{k} apm ( k ) pn ( n - k ) & ( 1 ) \\ w ( n ) = {\sum }_{i} {a}_{i} x ( n - i ) & ( 2 )\end{matrix}$$

If (2) is substituted with (1),

$$w ( n ) = {\sum }_{i} {a}_{i} {\sum }_{k} apm ( k ) pn ( n - k ) \qquad ( 3 )$$

Wherein, aᵢ can be obtained by extracting the characteristic of the digital contents using an auto-regression (AR) model, moving-average (MR) model, auto-regressive moving-average (ARMA) model, and etc.

Further, apm(k) is a coefficient of the audio absolute threshold filter of hearing of the digital audio used as the psycho-acoustic model 110 and is revised by analyzing the frequency characteristic generated from an audio signal to use publicly the audio absolute threshold of hearing of the psycho-acoustic model in the digital audio. Graph B shown in FIG. 9 is made by analyzing a total of 20 tunes of various types of the audio frequency and shows the audio absolute threshold curve. The graph is presented as the following formula, Y=P(1)x⁷+P(2)x⁶+. . . +P(7)x+P(8), wherein P means the value of coefficient showing the limited volume according to the frequency band and has the following values: [1.056801742606838e-026, −7.214332602361358e-022, 1.809126572761631 e-017, -1.941502598267307e-013, 5.982813623951169e-010, 4.211560372433627e-006, -3.420594737587419e-002, 8.533065083348841e+001]. The above coefficient values are given for exemplification and depend on changes according to the characteristics of the audio.

When the pseudo-random number sequence pn(k) is embedded into the digital contents, the psycho-acoustic model 110 changes the quality of the contents audibly to prevent from being discriminated against the signal wherein a watermark is not embedded. Generally, human's ears that perform the same role as a spectrum analyzer (a device analyzing frequency) react very sensitively to the audio generated in the frequency band of 3 kHz˜5 kHz, and are scarcely able to discriminate the audio of the frequency band of more than 10 kHz.

The psycho-acoustic model 110, which is made by using the frequency analyzing characteristics of such ear masks the frequency of the pseudo-random number sequence with the audio absolute threshold curve of hearing in order to minimize deterioration in the quality of the audio by the embedded information when embedding the pseudo-random number sequence into the audio.

The masking controls to weaken a signal of a sign sensitive to human's ears and embeds an original or a larger size of component in an insensitive frequency bandwidth.

Further, the psycho-acoustic model 110 makes the digital contents and embedded watermark signal to maintain the quality of the contents, and intensifies the characteristics of them under signal. Such characteristics can help detect the watermark by a component of the other parts, even if a part of the frequency component is removed since the size of signal is adjusted according to the characteristics of the audio frequency when masking the pseudo-random number sequence by using the psycho-acoustic model.

Moreover, since the psycho-acoustic model 110 is a device used in making a file transformation through most of the lossy compression (MP3, AAC, WMA), it minimizes loss of the watermark information. Omission of the psycho-acoustic model 110 is possible when a very simple processing of watermark is necessary. Omission of this process is possible when there is a limit in the amount of computation although this process is to change the characteristics of watermark and audio signal into the same type as possible.

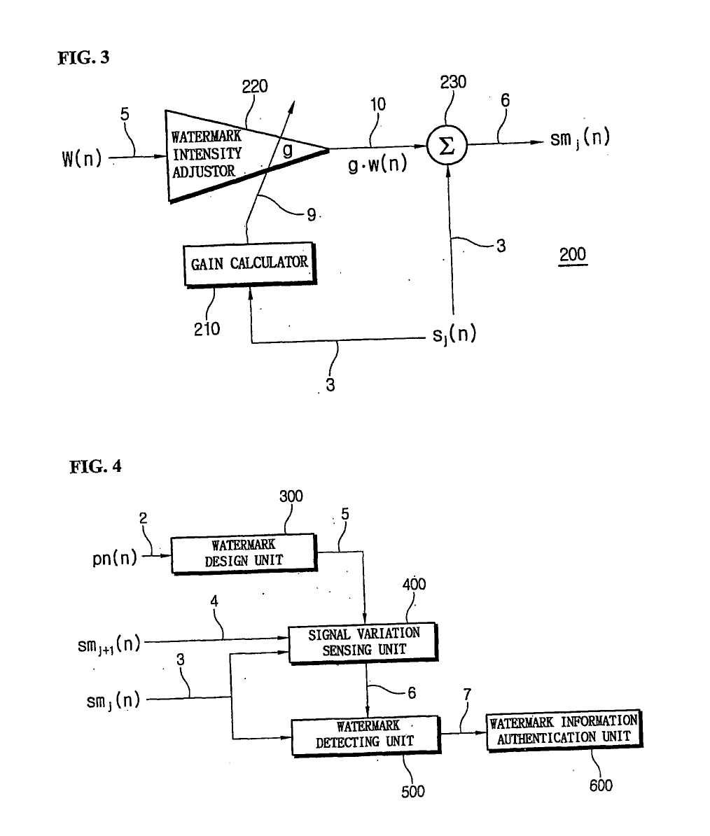

The watermark signal w(n) 5 generated from the watermark design unit 100 is embedded into the watermark embedding unit 200, and then the signal wherein the watermark is embedded into the digital contents is finally output. Such will be explained referring to the constitution of watermark embedding unit 200 shown in FIG. 3. The watermark embedding unit 200 comprises a gain calculator 210 for calculating the strength g (9) of the watermark which is embedded by measuring the amount of energy of the signal sⱼ(n) (3) of the digital contents, a watermark intensity adjustor 220 for adjusting the strength of watermark w(n) 5 which will be embedded according to the strength obtained by the gain calculator 210, and a watermark signal adder 230 for outputting the digital audio contents sⱼ(n) 6 where a watermark is embedded by adding and combining the watermark g.w(n) 10 to the signal of the digital contents.

The gain calculator 210 measures the amount of energy of the digital contents by using volume or the characteristics of the frequency distribution. The volume of audio is that of the music sound wherein the maximum value per frame is a reference and the frequency distribution is in a range of the frequency expressed by an audio and measures the amount of energy according to whether the frequency of audio is distributed equally or partially in the whole width band.

More specifically, the matter considered when deciding the strength of embedding watermark is the volume of audio, and the damage of the sound quality can be reduced only if the strength of watermark is changed in proportion to the volume of audio. For this, the audio data with the frame size is brought and then the frame size is divided by N. The reason for its division by N is to prevent the strength of watermark from growing much bigger since quite a big size of the frame results in a much difference in the sound volume of audio. For example, the frame size of 1470 is divided by the sub frame of 147 and then the strength of watermark is decided on the basis of the maximum value of each sub frame size.

Further, since audio differs in the distribution range of the frequency by genre, if the strength of watermark is decided using only the size of the sound volume, it [said watermark] is embedded in some music too minutely or too strongly. Hence, the strength of watermark should be decided considering genre of the music and using the distribution range of the frequency.

In the watermark embedding unit 200 having such constitution, the process presented in a formula is as follows:

smⱼ(n)=sⱼ(n)+g·w(n) (4)

The following formula can be obtained from formulas 1 to 3:

S_{j={s}(jN+n),n=0,1,Λ, N−1, J=0,1,Λ,J−1} (5)

$$\begin{matrix}{sm}_{j} ( n ) = {s}_{j} ( n ) + g \cdot {\sum }_{i} {a}_{i} {\sum }_{k} apm ( k ) pn ( n - k ) & ( 6 ) \\ {sm}_{j} = \{ {sm}_{1} , {sm}_{2} , Λ , {sm}_{j} \} & ( 7 )\end{matrix}$$

If watermark is embedded in the entire range of the digital contents, the digital contents smⱼ wherein watermark is embedded is finally obtained. When the digital contents are divided by the size of N and is composed of the number J, N is the length of the pseudo-random number sequence, and J is an integer obtained by dividing the length of the digital contents is divided by N. In the present application, the audio signal is divided into a frame with the size N and the watermark is embedded in each frame. Since watermark uses the pseudo-random number sequence, the size of watermark is the frame size of audio of N and thus J is the number of the frame.

A method of extracting watermark and device using the same according to the present invention will be explained with reference to the drawings.

FIG. 4 is a schematic block diagram showing constitution of a device for extracting the digital watermark according to the present invention. The device for extracting watermark in FIG. 4 includes a watermark design unit 300 similar to that used in the prior watermark embedding device, a signal variation sensing unit 400 for detecting whether there is a change in the digital contents, a watermark detecting unit 500 extracting watermark by comparing the watermark in the watermark design unit 300 with the watermark embedded in the digital contents, and a watermark information authentication unit 600 for performing the authentication operation of the corresponding information according to the result from extraction.

In order to extract watermark from the input digital contents, the watermark design unit 300 generates watermark w(n) 5 by using the generated pseudo-random number sequence and transmits it to the signal variation sensing unit 400. In case of the digital contents, watermark w(n) S is transmitted in the same form or in an order changed form during a transmitting process compared to the time when watermark is embedded. That is, in case that the signal processed in the digital contents removes a part of the watermark information, there should not be any difficulty in extracting (detecting) watermark. For this, a process of re-sampling watermark is executed.

For such process, the signal variation sensing unit 400 decides on whether the signal processed in the digital by using the contents signals smⱼ(n) and smⱼ₊₁(n) which are adjacent contents to each other affects the watermark detecting unit 500. In case that the signal processing affects the watermark detecting unit 500, for example, the proceeding speed of the digital contents is arbitrarily changed or a part of signal is removed, watermark w(n) (5) is re-sampled, and then the sampled watermark w(n) (6) is delivered to the watermark detecting unit 500. If there is no change in the digital contents, there is no change in the length of watermark. However, if a change happens, n, the length of watermark is re-sampled to ñ. On the supposition that no change happens in the digital contents, the explanation will be made with the following formulas.

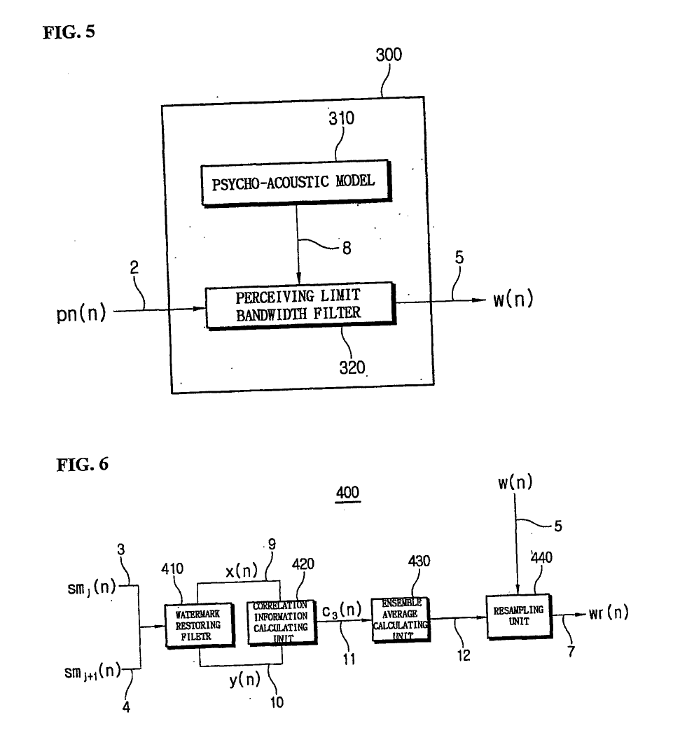

The watermark detecting unit 500 calculates amount c(n) of the correlation information between watermark wr(n) designed in the watermark design unit 300 and the watermark wr(n) in the digital contents signal smⱼ(n) wherein watermark is embedded, and from the calculated correlation information, said unit extracts whether a watermark is embedded and extracts the embedded information through the watermark information authentication unit 600. The above-mentioned explanation separately represents the watermark detecting unit 500 and the watermark information authentication unit 600, but only the watermark detecting unit 500 can be constituted. The process of extracting from the digital contents where such watermark is embedded will be more specifically explained referring to FIG. 5 to FIG. 7.

FIG. 5 shows the watermark design unit for extracting watermark similar to that shown in FIG. 2. Only, it is not necessary to adjust the intensity of watermark embedded in the digital contents in the watermark design unit 300 which is included in the extracting device. Thus, the watermark design unit comprises the psycho-acoustic model 310 and the perceiving limit bandwidth filter 320. The motion of the above watermark design unit 300 is similar to the constituent shown in FIG. 2. Therefore, the detailed explanation will be omitted.

FIG. 6 is a detailed block diagram showing the constitution of signal variation sensing unit 400 in FIG. 4. The signal variation sensing unit 400 in FIG. 6 comprises a watermark restoring filter 410 for its inverse transformation since signal variation sensing unit 400 is transformed into the characteristics of the digital contents when watermark is embedded into the digital contents, a correlation information calculating unit 420 for measuring the auto correlation information of the digital contents where watermark is embedded, an ensemble average calculating unit 430 to strengthen the correlation information using a ensemble average considering that watermark is equally included in the digital contents, and a resampling unit 440.

Signal variation sensing unit 400 receives two digital contents signals, smⱼ(3) and smⱼ₊₂(4) which are adjacent to each other as input signals to detect a change in the digital contents. When the above two signals are input, the watermark restoring filter 410 executes a process of transforming inversely itself again since it is transformed into the characteristics of the digital contents when watermark is embedded into the digital contents, i.e., a process of restoring to the status prior to embedding a signal of watermark embedded in the digital contents. However, although watermark is not designed elaborately or restored during the extracting process with elaboration, it does not affect the extracted result much, thus, this process can be omitted.

When the restoring process is completed, the auto correlation information of the watermark embedded digital contents is determined through the measurement without using watermark to decide on how the signal of the digital contents changes. The correlation information calculating unit 420 extracts the correlation information between the digital contents signals of smⱼ(n) and smⱼ₊₁(n). After calculation, since watermark is equally included in the digital contents, the ensemble average calculating unit 430 strengthens the correlation information using the ensemble average.

Finally, considering the correlation between watermark w(n) input from the watermark design unit 300 and watermark embedded in the digital contents, if no change in the digital contents is found, there is no change in the length of watermark in case of no change in the digital contents. However, when there is a change, the resampling unit 440 outputs watermark wr(n) of which the length is resampled from ñ to ñ.

A process for removing unnecessary information generated through the correlation of watermarks made by the above process will be expressed using equations as follows:

Watemark-embedded digital signals smⱼ(n) 3 and smⱼ₊₁(n) 4 adjacent to smⱼ(n) 3 output from watermark restoring filter 410, i.e. inverse auto regression filter, are presented in the form of x(n) 9 and y(n) 10 as follows:

$$\begin{matrix}x ( n ) = {\sum }_{i} {b}_{i} {sm}_{j} ( n - i ) & ( 8 ) \\ y ( n ) = {\sum }_{i} {b}_{i} {sm}_{j + 1} ( n - i ) & ( 9 )\end{matrix}$$

Here, since smⱼ(n)=w(n)+sⱼ(n), the following formula is obtained if this is put into Equation (8):

$$x ( n ) = {\sum }_{i} {b}_{i} ( w ( n - i ) + {s}_{j} ( n - i ) ) = {\sum }_{i} {b}_{i} w ( n - i ) + {\sum }_{i} {b}_{i} {s}_{j} ( n - i ) \qquad ( 10 )$$

Here, if sⱼ(n) is random and sⱼ⊥sⱼ, if i ∫j, it is expressed as the following watermark information and errors:

x(n)=w(n)+eⱼ(n) (11)

y(n)=w(n)+eⱼ₊₁(n) (12)

The two signals x(n) and y(n) obtained from the above are input into the correlation information calculating unit 420, and then the amount s₃(n) 11 of the correlation information is calculated. After calculation of the correlation information, the ensemble average is determined by using the correlation information in the ensemble average calculating unit 430. The ensemble average divides the audio signal by the size of N, which is called a frame each by each, and said each frame is added and averaged to an average frame, which is called an ensemble average, which is expressed as the following formula:

$$c ( n ) = Σ x ( n ) y ( n + k ) = {\sum }_{k} ( {w}_{D} ( n ) + {e}_{j} ( n ) ) ( {w}_{D + 1} ( n + k ) + {e}_{j + 1} ( n + k ) ) \\ = {\sum }_{i} [ w ( n ) w ( n + i ) + ϵ ( n ) ] ( {e}_{j} ⊥ {e}_{i} = 0 ) \qquad ( 13 )$$

If the signal processing on the digital contents affects only the strength, the signal c(n) calculated herefrom can obtain a peak of the maximum value (or minimum value) per length of the watermark used in its early embedding. For example, if there is no change in the length of the digital contents such as change due to an attack of weakening the watermark information through noise or filtering, i.e., a simple attack of noise or signal processing, a peak appears in a period of the length (N) of watermark used when the watermark signal is embedded.

However, if a signal processing increases or decreases the audio length, a peak appears per length of ñ. Therefore, the watermark signal wr(n) is obtained by resampling the watermark w(n) using such information. It is possible to use an known method for resampling and, when a high-speed processing is necessary, it is better to use a spline extrapolation.

For example, there could be an attack (representatively, “pitch shift”) which gives a change in the length of the digital contents preventing watermark from being found by embedding different sample signals amid the digital contents. In this case, the length of frame is changed. For example, if the length of the digital contents increases by 10% and the size of frame used in embedding watermark is n, the size of frame after being attacked is N*1.1, and thus the peak value of the correlation which confirms the existence and non-existence of watermark during the process of extracting watermark appears in every n*1.1.

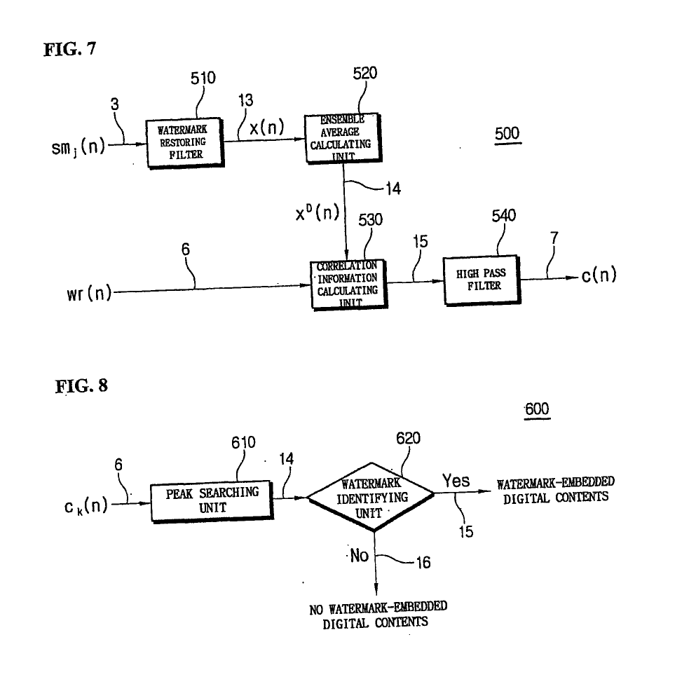

FIG. 7 is a block diagram showing the detailed constitution of the watermark detecting unit 500 in FIG. 4 and shows the constitution of extracting for determining the amount of the correlation information which is consistent with watermark in the correlation information between the watermark-embedded digital contents and watermark. The watermark detecting unit 500 in FIG. 7 includes a watermark restoring filter 410 for executing the same function as that of the watermark restoring filter 410 used in the signal variation sensing unit 400 in FIG. 6, an ensemble average calculating unit 520 for strengthening the intensity of the watermark signal in the restored digital contents, a correlation information calculating unit 530 for calculating the correlation information between the watermark from the signal variation sensing unit 400 and the watermark-embedded digital contents, and a high pass filter 540 for extracting only the signal information generated between watermarks in the calculated correlation information.

In the above constitution, the watermark restoring fitter 410 and the ensemble average calculating unit 520 have the same function as used in the signal variation. sensing unit 400 as described above, and thus detailed explanation thereof is omitted.

First, in case that the embedded watermark is properly changed according to characteristics of the audio signal and then embedded, water-embedded digital contents undergo the process of the watermark restoration. The expression thereof using an equation is as follows:

$$x ( n ) = {\sum }_{i} {b}_{i} {sm}_{j} ( n - i ) \qquad ( 14 )$$

where, smⱼ(n) indicates a signal of the watermarked digital. contents and bⱼ indicates a restoration filter coefficient. In order to strengthen the watermark signal, the ensemble average calculating unit 520 removes the periodicity of the digital contents and simultaneously adds the embedded watermark repeatedly. By such calculation, the watermark signal is considered as a main signal, and the digital contents signal is considered as a noise. At this time, if the digital contents signal sⱼ(n) is random and sⱼ⊥sᵢ, if i∫j, the watermark x^{D}(n) can be extracted by the ensemble average.

x(n)=w(n)+sⱼ(n) (15)

$${x}^{D} ( n ) = \frac{1}{k} {\sum }_{j = 1}^{k} [ w + {s}_{j} ] \qquad ( 16 )$$

Therefore, x^{D}(n)∫w(n) is established.

The correlation information calculating unit 530 is the same as the correlation information calculating unit 420 in the above FIG. 6. In this case, the correlation information with watermarks is concealed by the periodic characteristics of the digital audio, thus is scarcely discriminated. The present invention provides a method for extracting the correlation information of watermark that is concealed by the periodic characteristics of the digital audio. By using the fact that correlation information has a considerable characteristics of high frequency, while the periodic characteristics of the digital audio has low frequency, only the watermark information can be extracted by a high pass filtering of the correlation information as a hanning window. Such extraction process is presented by the following equation:

$$\begin{matrix}c ( n ) = {\sum }_{k = 1}^{N} {x}^{D} ( n ) w r ( n + k ) & ( 19 ) \\ {c}^{D} ( n ) = {\sum }_{i}^{N} hw ( n ) c ( n + i ) & ( 20 )\end{matrix}$$

The calculated correlation information c(n) is filtered with the high pass filter hw(n), and thus the periodic characteristics of the digital audio contents are excluded and the watermark correlation information is extracted. At the time the above extracted correlation information c^{D}(n) is identical to the watermark information, the amount of correlation has quite a higher value than when the correlation amount is not identical.

FIG. 8 shows the constitution of the watermark information authentication unit 600 which extract the information and whether or not the watermark is embedded through c^{D}(n) obtained from the watermark detecting unit 500 in FIG. 4. The watermark information authentication unit 600 in FIG. 8 comprises a peak searching unit 610 for searching a peak in the extracted watermark and a watermark identifying unit 620 for determining whether watermark is embedded or not according to the searched peak.

The peak searching unit 610 of the watermark information authentication unit 600 having the constitution described above extracts a particular solution which appears at the time the watermark-embedded digital contents are consistent with watermark. That is, said peak searching unit 610 extracts whether there is a peak having value bigger than a predetermined value and a critical value. The point when a particular solution appears can be predicted since it occurs at a constant interval defined in the embedding process.

In the watermark identifying unit 620, if the extracted particular solution has a value much higher than other value of the correlation information, the digital contents contain the watermark, and if said solution does not have such higher value, the digital contents don't contain watermark. Further, if ‘10010011’is embedded as watermark information during the embedding process, the positive peak appears when a bit information is ‘1’, and the negative peak appears when a bit information is ‘0’. Thus, the watermark information of ‘10010011’ can be easily extracted. The capability of extraction with regard to the digital audio contents will be explained by means of the following Embodiments.

### Comparision of Ability of Detecting Watermark In The Digital Audio Data With The Strong Periodicity

Since the digital audio has periodicity higher than picture signal such as image and video, it is difficult to discriminate whether the watermark exists or not just by the watermark detecting device already known. It is because the correlation information in watermark is concealed by a strong periodicity which the digital audio signal itself has when the correlation information between the watermark-embedded digital audio and watermark is obtained.

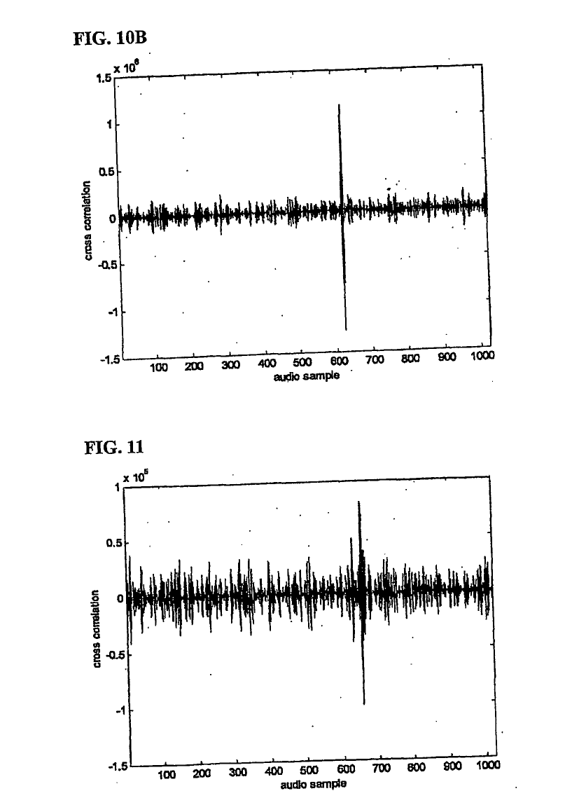

FIG. 10A is a result obtained from the existing calculation method of the correlation information, and FIG. 10B is a result obtained from using the watermark perceiving method suggested in the present invention. In case of using the existing calculation method of the correlation coefficient in FIG. 10A, it is impossible to determine whether watermark is embedded due to the periodic characteristics of the audio, whereas in case of using the watermark detecting method suggested in the present invention, as shown in FIG. 10B, it is possible to detect the watermark with ease since a high value of the correlation coefficient appears at the frequency of the watermark.

### Evaluation of Robustness of Watermark Against Lossy Compression

The digital audio needs the largest amounts of the contents. In particular, it uses many compression algorithm such as ISO/IEC 13818-7 (AA), ISO/IEC 14496-3 (MPEG-4 AAC), ISO/IEC 11172-3 (MP3), Window Media Audio, Twin-VQ, etc. for a real time transmission through Internet. If watermark is not strong against such lossy compression, it is not possible to utilize watermark for a copyright claim or protection. Thus, watermark should be able to be detected after the lossy compression. In case of using the method for embedding/detecting watermark suggested in the present invention, the watermark is very strong against the lossy compression algorithms known up to now, and the existence of watermark after the lossy compression apparently appears through the correlation coefficient. FIG. 11 is a result obtained from detecting watermark after the lossy compression.

### Example of a Method of a Embedding a Bit Information and Restoring Information

The decision only as to whether or not watermark exists makes a copyright protection and the chase of illegal copy difficult. Accordingly, a device for embedding/extracting watermark should include a predetermined amount of information in the digital contents through watermark.

An method for embedding information will be explained with an example of embedding and extracting whether or not a 4 bit-information exists. If a ‘1010’ information is embedded during the watermark embedding process as described above when a bit information is ‘1’, watermark is embedded to have the correlation of the positive, and when a bit information is ‘0’, watermark is embedded to have the correlation of the negative. Such repeated embedding of watermark enables longer information to be easily obtained. Further, in case of embedding a long information, it is necessary to understand the order of information. Since information is not always extracted in the same order, watermark produced by using a different value of key is embedded into the k th signal, thereby the order can be easily prevented from being disarranged.

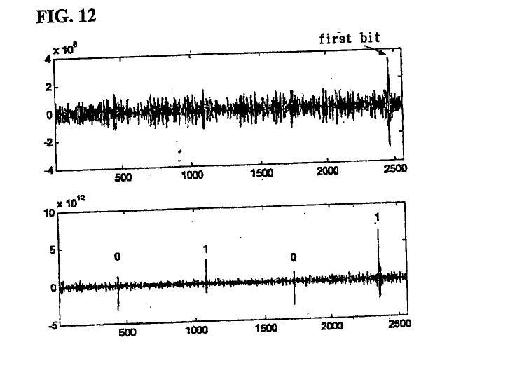

For example, when the watermark produced as a key value of ‘1234’ is embedded, and the first bit information ‘1’ produced as a key value of ‘1235’ is embedded, only this signal is discriminated as watermark differently produced. Otherwise, it enables the starting point of information to be found by adjusting the size of the strength of watermark. FIG. 12 shows a result of extraction when embedding a 4-bit information. It can be understood that the first peak from the right in the above-mentioned figure is a starting point.

### Industrial Applicability

A psycho-acoustic model is formed in order not to affect the audio characteristic of the digital audio when embedding a digital watermark in the digital audio contents according to the present invention as described above, and an audio absolute threshold of hearing is used in filtering. Thus, it prevents the signal in which a watermark is not embedded from being discriminated by audibly changing the quality of the contents. Further, since the psycho-acoustic model is made by using person's splitting characteristics with respect to audio, the embedded information enables a deterioration of quality of the audio to be minimized when a watermark is embedded in the digital audio contents.

Further, the psycho-acoustic model has a characteristic strong in processing a digital signal while the digital contents and the embedded watermark signal maintain conservation of the digital contents and quality of the contents. Such characteristics can help detect the watermark by a component of the other parts, even if a part of the frequency component is removed since the volume of signal is adjusted according to the characteristics of the audio frequency when masking the pseudo-random number sequence by using the psycho-acoustic model.

Further, when extracting the embedded watermark according to the present invention, watermark can be successfully extracted in a case where a part of the watermark disappears. The watermark included in the digital audio contents can be easily extracted by strengthening the watermark signal during the process.

As described above, the present invention provides a method for extracting watermark embedded from the signal with a strong periodicity such as the digital audio in a high-speed manner and in effectiveness. It is possible to extract the embedded information by such extraction method as long as deterioration in the quality of the audio contents maintains the commercial value of audio even after the attack of an audio signal processing (analog to digital transformation, transformation in a sampling ratio, transformation in a linear speed, lossy compression, echo hiding).

The present invention is particularly shown and described referring to the above Embodiments, however, which are used for examples. An ordinarily skilled person in the art to which the present invention pertains can make various revisions without deviating beyond the mind and scope of the invention as defined in the claims attached hereto.

1. (Amended) A method for embedding a digital watermark in the digital audio contents, comprising:
generating a digital watermark by filtering a predetermined length of pseudo random sequence with audio absolute threshold of hearing in order not to affect the audio characteristics of said digital audio contents; and
embedding said digital watermark in said digital audio contents.

3. (Amended) The method according to claim 1, wherein generating said digital watermark includes:
forming a psycho-acoustic model having the audio absolute threshold of hearing according to the characteristics of the frequency generated from said digital audio contents;
filtering said pseudo random number sequence in accordance with said psycho-acoustic model; and
filtering said filtered pseudo random number sequence by using composed filtering coefficient which indicates the general characteristics of said digital audio contents.

5. (Amended) The method according to claim 1, wherein embedding said digital watermark in said digital audio contents includes:
measuring the amount of energy of said digital audio contents;
adjusting the strength of said digital watermark according to said measured amount of energy; and
adding up said digital watermark with adjusted strength with said digital audio contents.

8. (Amended) A method for extracting a watermark from the digital audio contents, the method including:
generating a watermark from pseudo random number sequence by forming a psycho-acoustic model having an audio absolute threshold of hearing according to the characteristics of frequency generated from said digital audio contents; and
extracting the embedding of watermark by measuring the correlation between said watermark and said digital audio contents.

9. (Amended) The method according to claim 8, further including adjusting the length of said watermark by detecting whether or not the signal is processed with regard to the corresponding digital audio contents from the digital audio contents which are adjacent to each other after said step of generating watermark.

10. (Amended) The method according to claim 9, wherein generating said watermark includes:
forming a psycho-acoustic model having audio absolute threshold of hearing according to the characteristics of frequency generated from said digital audio contents; and
generating said watermark by filtering said pseudo random number sequence in accordance with said psycho-acoustic model.

11. (Amended) The method according to claim 10, wherein adjusting the length of said watermark includes:
restoring back to its original form regarding the signal processed when embedding watermark is performed regarding said adjacent digital audio contents;
extracting the information of correlation among said restored adjacent digital audio contents; and
resampling said watermark according to said information of correlation.

12. (Amended) The method according to claim 11, further including strengthening said information of correlation after said step of extracting.

13. (Amended) The method according to claim 11, wherein said restoring is conducted by inverse-auto regression filter.

14. (Amended) The method according to claim 12, wherein said strengthening the information of correlation performs the calculation of the ensemble average.

15. (Amended) The method according to claim 11, wherein said extracting said embedding of watermark includes:
restoring back to its original form regarding the signal processed when embedding watermark is performed in said adjacent digital audio contents;
strengthening the component of said digital watermark among said restored digital audio contents;
calculating the information of correlation between two signals of said watermark with adjusted length and said digital audio contents with strengthened digital watermark; and
extracting the information of watermark correlation by filtering said calculated and extracted correlation information to remove the periodic property of said digital audio contents.

16. (Amended) The method according to claim 15, further including determining whether watermark is embedded from said correlation information of the extracted watermark after said step of extracting watermark.

17. (Amended) A device for embedding watermark in the digital audio contents, the device including:
means for generating the digital watermark by filtering a predetermined length of pseudo random sequence with audio absolute threshold of hearing in order not to affect the audio characteristics of said digital audio contents; and
means for embedding said digital watermark in said digital audio contents.

18. (Amended) The device according to claim 17, wherein the means for generating said digital watermark includes:
means for forming a psycho-acoustic model having the audio absolute threshold of hearing from analyzing the characteristics of frequency generated from said digital audio contents;
means for filtering said pseudo random number sequence in accordance with said psycho-acoustic model; and
means for filtering said filtered pseudo random number sequence by using composed filtering coefficient which indicates the general characteristics of said digital audio contents.

20. (Amended) The device according to claim 17, wherein the means for embedding said digital watermark includes:
means for measuring the amount of energy of said digital audio contents;
means for adjusting the strength of said digital watermark according to said measured amount of energy; and
means for adding up said digital watermark with adjusted strength with said digital audio contents.

23. (Amended) A device for extracting watermark from the digital audio contents, the device including:
means for generating a watermark by forming a psycho-acoustic model having an audio absolute threshold of hearing from analyzing the characteristics of frequency generated from said digital audio contents; and
means for extracting the embedding of watermark by measuring the correlation between said watermark and said digital audio contents.

25. (Amended) The device according to claim 24, wherein said means for adjusting the length of the watermark includes:
means for restoring back to its original form regarding the signal processed when embedding watermark is performed regarding said adjacent digital audio contents;
means for extracting the information of correlation among said restored adjacent digital audio contents; and
means for resampling said watermark according to said information of correlation.

29. (Amended) The device according to claim 25, wherein said means for extracting the embedding of watermark includes:
means for restoring back to its original form regarding the signal processed when embedding watermark is performed regarding said adjacent digital audio contents;
means for strengthening the component of said digital watermark among said restored digital audio contents;
means for calculating the information of correlation between two signals of said watermark with adjusted length, and said digital audio contents with strengthened digital watermark; and
means for extracting the information of watermark correlation by filtering said calculated and extracted correlation information to remove the periodic property of said digital audio contents.
